(19) United States
(12) Patent Application Publication
(10) Pub. No.: US 2024/0144370 A1
(43) Pub. Date: May 2, 2024

(54) AUTOMATED MARKET MAKER (AMM) SMART CONTRACTS

(71) Applicant: Eric Falkenstein, Eden Prairie, MN (US)

(72) Inventor: Eric Falkenstein, Eden Prairie, MN (US)

(21) Appl. No.: 18/499,980

(22) Filed: Nov. 1, 2023

Related U.S. Application Data
(60) Provisional application No. 63/421,546, filed on Nov. 1, 2022.

(51) Int. Cl. G06Q 40/04; G06Q 20/38

(52) U.S. Cl. CPC G06Q 40/04; G06Q 20/389

(57) ABSTRACT

Methods, systems, and apparatus, including computer programs encoded on computer storage media, for AMM smart contracts. One of the methods includes providing a smart contract on a decentralized blockchain network; receiving, in a first account maintained within the smart contract for a liquidity provider (LP) entity, an initial deposit amount associated with the digital asset and a second digital asset; receiving a request from the LP to execute a trade of the first digital asset between the first account of the LP entity and a second, margin account of the LP entity; determining that a total amount of the first digital asset in the first account and the second, margin account of the LP entity after accounting for the trade is within a predetermined range of the initial position of the LP entity; and executing, on the smart contract, the trade of the first digital asset between the first account of the LP entity and the second, margin account of the LP entity.

### CROSS-REFERENCE TO RELATED APPLICATIONS

This application claims the benefit under 35 U.S.C. § 119(e) of the filing date of U.S. Patent Application No. 63/421,546, which was filed on Nov. 1, 2022, and which is incorporated herein by reference.

### TECHNICAL FIELD

This specification relates to blockchain technologies including automated market maker (AMM) smart contracts.

### BACKGROUND

Smart contracts are self-executing computer programs that can be deployed in a decentralized blockchain to automatically perform operations.

Blockchains can consume a significant amount of energy. Electricity usage within blockchains, including electricity usage for performing processes of smart contracts, contributes to increased carbon emissions worldwide. In China alone, energy usage from blockchain technology is expected to exceed 250 terawatt hours and generate over 130 million metric tons of emissions.

### SUMMARY

This specification describes technologies for reducing energy usage and enabling sustainable automated market maker (AMM) smart contracts in decentralized blockchains. Improving efficiency can include reducing loss from liquidity provider (LP) entities to the AMM. AMMs are integral parts of decentralized finance (DeFi) ecosystems that allow for automatic and permissionless trading of digital assets through the use of liquidity pools formed from digital assets deposited by the LP entities. The decentralized nature of AMMs (and DeFi ecosystems in general) introduce inherent latencies in transactions being executed and stored (e.g., on a blockchain). The inherent latencies associated with the underlying technological environments can be a detriment for the LP entities to participate in the AMM, for example, by limiting the feasibility of the LP entities participating in price-setting transactions.

In general, one innovative aspect of the subject matter described in this specification can be embodied in methods that include the actions of providing a smart contract on a decentralized blockchain network, the smart contract configured to support an automated market maker (AMM) exchange, the smart contract comprising software code regulating the trading of the first digital asset on the AMM; receiving, in a first account maintained within the smart contract for a liquidity provider (LP) entity, an initial deposit amount associated with the digital asset and a second digital asset, the combined value of the initial deposit amounts corresponding to the first and second digital assets defining an initial position of the LP entity; receiving a request from the LP to execute a trade of the first digital asset between the first account of the LP entity and a second, margin account of the LP entity, wherein the trade of the first digital asset between the first account and the second, margin account involves transfer of the second digital asset between the first account and the second, margin account, and the trade affects a market price of the first digital asset; determining that a total amount of the first digital asset in the first account and the second, margin account of the LP entity after accounting for the trade is within a predetermined range of the initial position of the LP entity; responsive to determining that the total amount of first digital asset in the first account and the second, margin account of the LP entity is within the predetermined range, executing, on the smart contract, the trade of the first digital asset between the first account of the LP entity and the second, margin account of the LP entity; and computing, on the smart contract, a price of the first digital asset based on the trade of the first digital asset between the first account of the LP entity and the second, margin account of the LP entity. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, actions include computing, on the smart contract, a trade fee discount associated with the trade, the trade fee discount being computed as a function of a difference between (i) the initial position and (ii) the total amount of the first digital asset in the first account and the second, margin account of the LP entity after accounting for the trade.

In some implementations, actions include receiving a withdrawal request from either the first account or the second, margin account; determining that the withdrawal request has been received after a threshold duration from a predetermined time point; and responsive to determining that the withdrawal request has been received after the threshold duration from the predetermined time point, initiating a fund transfer in accordance with the withdrawal request; and storing a record of the fund transfer on the decentralized blockchain network. In some implementations, the threshold duration is one week.

In some implementations, actions include generating a record of a stable coin based on the total amount of the digital asset in the first account and the second, margin account. In some implementations, the smart contract is provided in a leveraged automated market maker (LAMM) in the decentralized blockchain network.

The technology described in this specification can be implemented so as to realize one or more of the following advantages. For example, techniques include generating and providing a smart contract within an AMM on a decentralized blockchain, wherein the smart contract allows for increased efficiency and energy reduction. The smart contract can include one or more rules to eliminate impermanent loss for providers to pools used within the AMM. The smart contract can be configured to help reduce a number of transactions that occur to effectively adjust an AMM price—e.g., a value for one or more digitized tokens recorded in the blockchain. By setting a threshold level of change in value, the smart contract can help prevent one or more transactions performed by LPs to adjust an AMM price. The smart contract can be configured to allow LPs to trade with one or more accounts to avoid value reducing third party traders, e.g., accounts not associated with LPs, from trading corresponding to one or more ranges in value. The smart contract can be configured to compress one or more operations previously performed using two or more smart contracts. Compression can, e.g., improve efficiency of the smart contract by reducing the number of smart contracts included in each of one or more blocks of a blockchain or reduce the number of lines of code processed for one or more transactions processed by the smart contract compared to code processed using multiple smart contracts which might include more combined lines of code than the proposed compressed smart contract.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example environment for AMM smart contracts.

FIG. 2 shows a flowchart of an example process for an AMM smart contract.

Like reference numbers and designations in the various drawings indicate like elements.

### DETAILED DESCRIPTION

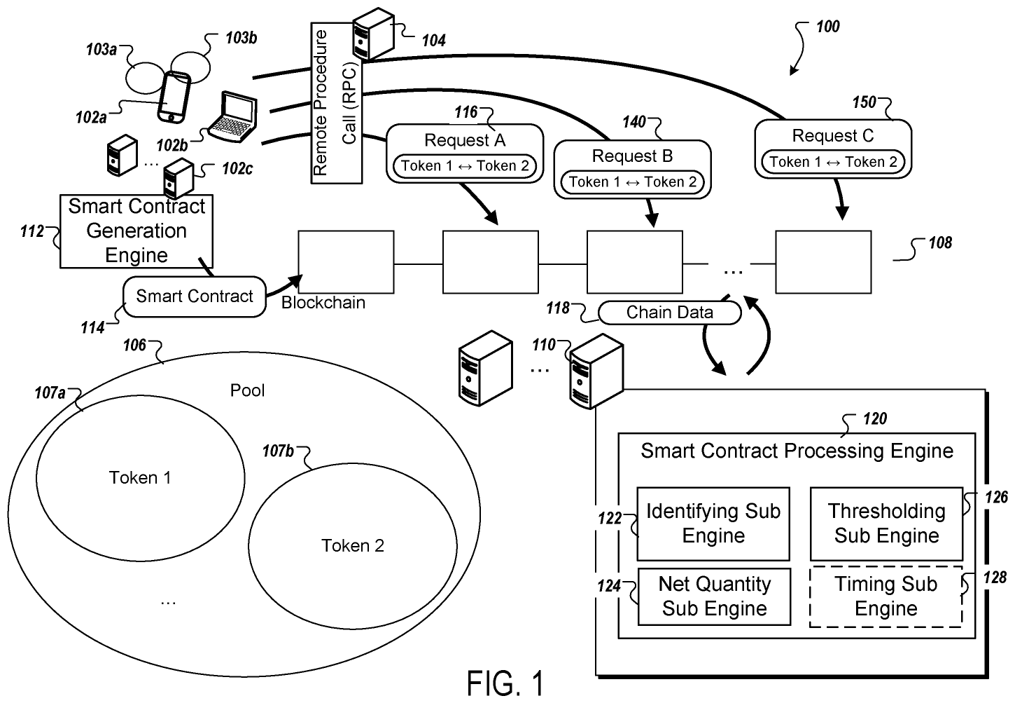

FIG. 1 shows an example environment 100 for AMM smart contracts. The environment 100 includes entities, such as entities 102a-c, and a blockchain 108. The entities can be users of blockchain 108. In the example of FIG. 1, the entities 102a-c represent devices that access the blockchain 108 using the remote procedure call (RPC) node 104 as an interface. The RPC node 104 can be one of multiple nodes used as an interface to the blockchain 108. The entities can generate or process a smart contract 114 that is provided to the blockchain 108. In the example of FIG. 1, the entity 102c generates the smart contract 114 and provides the smart contract 114 to the blockchain 108—e.g., in a transaction. Entity 110 represents a processing node configured to process the smart contract 114. The processing node 110 can be one of multiple processing nodes used in the environment 100. In some cases, different processing devices generate or process the smart contract. In general, one or more of the entities 102a-c, the RPC node 104, or entity 110 can be configured to process the smart contract 114. The entities 102a-c, the RPC node 104, and the entity 110, can include one or more computers configured to perform operations described in this document.

Entities 102a-c can generate requests for transfers of tokens—e.g., Ethereum to USD stablecoins. Requests can be processed by the entity 110, such as transaction requests. Requests can be processed by one or more entities of the environment 100, either simultaneously or asynchronously with the processing of the entity 110. The device 102c can generate the smart contract 114 using a smart contract generation engine 112. The smart contract generation engine 112 can operate on one or more computers—e.g., the device 102c. The smart contract generation engine 112 can generate the smart contract 114 configured to process requests. The smart contract generation engine 112 can be configured to deploy the smart contract 114 onto the blockchain 108—e.g., within one or more blocks of the blockchain 108. The smart contract 114 can be used in an AMM.

In some implementations, the smart contract 114 is generated to help eliminate impermanent loss (IL) for liquidity providers (LPs) in the AMM of the environment 100. For example, the smart contract 114 can include one or more specific rules to improve the AMM. Rules can include adjustments of trading fees depending on identified, stored, values of the blockchain 108. Rules can include restrictions on specific types of transfers, e.g., transfers out of a liquidity pool by an account that fails to satisfy a time requirement. Rules can include identification requirements, e.g., distinguishing rule applications of LP entities compared to non-LP entities. Additional discussion of the rules of the smart contract 114 are included in the discussion of a smart contract processing engine 120 of the entity 110.

In some implementations, the smart contract 114 is configured to perform operations including one or more of token swaps, perpetual contracts (e.g., trading perpetual contracts, spot markets, or margin trading), stable coin processes (e.g., generation, trading, among others), eliminating IL (e.g., LP arbitraging using multiple accounts).

Subsequent to providing the smart contract 114, one or more entities can request transfer of tokens. For example, the entity 102a can generate and transmit request A 116 to the blockchain 108. The request 116 indicates a transfer of tokens in pool 106, e.g., to or from token 1 account 107a or token 2 account 107b. Tokens included in the pool 106 can include any type of token available in a blockchain, e.g., Ethereum, Bitcoin, USD, or the like.

Request A 116 can be processed by one or more nodes of the blockchain 108—e.g., processing nodes for performing consensus mechanisms. FIG. 1 shows processing by the entity 110 in detail. The entity 110 includes the smart contract processing engine 120. The smart contract processing engine 120 includes one or more sub engines, including an identifying sub engine 122, net quantity sub engine 124, thresholding sub engine 126, and a timing sub engine 128. In some cases, the timing sub engine 128 is an optional engine. Each of the sub engines can be configured to perform operations of the smart contract 114 configured by the smart contract generation engine 112. The request A 116 is shown included in a block separate from the other requests—e.g., request B 140 and request C 150. In some cases, one or more of the requests are included in the same block in the blockchain 108. The requests 140 and 150 can originate from other LPs or the same LP or entity that provides the request A 116.

In processing the request A 116, the identifying sub engine 122 can identify one or more accounts of the request A 116. The identifying sub engine 122 can obtain information from the blockchain 108 included in the chain data 118. The chain data 118 can include request data or state data of the smart contract 114—e.g., included in each block subsequent to the block including the initial transaction of the smart contract 114. The identifying sub engine 122 can parse the blockchain 108 for data.

If the request A 116 is generated and transmitted by the entity 102, the identifying sub engine 122 can identify one or more accounts associated with the entity 102—e.g., margin accounts, trading accounts, or accounts indicating value included in the pool 106. In some implementations, the identifying sub engine 122 can identify if the request A 116 indicates an account that includes at least some value from the pool 106 which are being requested in the request A 116. In this case, the identifying sub engine 122 can identify the entity 102 as an LP. In response, a trading fee can be removed or adjusted. For non-LP requests, the identifying sub engine 122 can increase or otherwise adjust a trading fee to a non-zero value. In some implementations, the trading fee for non-LPs is a percentage of the proposed requested transfer or trade. For example, if the request A 116 includes a request to transfer 1 ETH for 100 USD, the corresponding fee if the requester is a non-LP—e.g., a liquidity provider (LP) to at least one account of the pool 106—can be a percentage, such as 0.2% of the value of at least one of the tokens. If the requester is an LP—e.g., the corresponding entity provides liquidity to the pool 106—the identifying sub engine 122 can adjust a trading fee to 0 or other value. The value for the LP trades can be less than the non-LP trades.

For example, the smart contract 114 can obtain a user's basic account information, e.g., in a ‘struct’ named tradeAccount. A user interacting with the smart contract 114 can be identified by the smart contract 114 processor as msg.sender. The owner of the private key of that msg.sender address can send transactions as that msg.sender. The smart contract 114 can determine if a user is an LP by checking if their account has positive liquidity, e.g., in the pool 106.

In some implementations, the identifying sub engine 122 can provide data identified in the blockchain 108 to other sub engines, such as the net quantity sub engine 124. The net quantity sub engine 124 can process data of the request A 116. For example, the net quantity sub engine 124 can determine a net quantity of tokens included in accounts identified by the identifying sub engine 122. In the case of the entity 102, the net quantity sub engine 124 can generate net quantities of a first token—e.g., included in the token 1 account 107a—and a second token—e.g., included in the token 2 account 107b. The first and second token can be any suitable token, e.g., ETH, USD, Tether, among others. In some implementations, the net quantity sub engine 124 can identify whether or not an account is associated with a given entity, such as the entity 102a. In response to determining the account is associated with the entity 102a, the net quantity sub engine 124 can determine a type of token included in the account. For all two or more accounts that include the same token, the net quantity sub engine 124 can generate a net quantity of that token to generate a net quantity for each token included in accounts of the given entity.

In some cases, the smart contract 114 processor determines one or more of tokens to be traded, a number of tokens owned by various user accounts within the smart contract 114, or functions for determining how many of a given token can be acquired by sending the smart contract 114 another token. Functions of the smart contract 114 can be affected by its state, a size and composition of its trading pool, which can be read from a contract's database balance—e.g., sqrt(p1)=sqrt(p0)+USDCin/liquidity—where liquidity and p0 can represent initial state variables in the contract prior to a transaction, and p1 can represent an updated price state variable.

In some implementations, the net quantity sub engine 124 provides data to the thresholding sub engine 126. For example, the thresholding sub engine 126 can obtain one or more net quantity tokens generated by the net quantity sub engine 124. The net quantities can include a quantity of tokens for each token included in accounts of a given requesting entity—e.g., entity 102. The thresholding sub engine 126 can apply one or more thresholds to determine one or more transactions to initiate on the blockchain 108. Thresholds can include thresholds based on net quantities of tokens. For example, a threshold can include an amount of a token of the request A 116. As discussed below, in a case of multiple LPs, thresholding processing can help eliminate IL from a single LP using no-fee trading to obtain value from the other LPs. Thresholding can enforce limits on a single LPs ability to arbitrage against a corresponding pool. In some implementations, a threshold applied by the thresholding sub engine 126 includes an inequality determination. For example, the thresholding sub engine 126 can determine if a number of initial net tokens is more or less than a number of current net tokens, for a given token type. By comparing initial and current, the thresholding sub engine 126 can determine if a given trader, such as an LP, has already captured value or if it has not.

In some cases, the contract includes rules that apply different fees or requirements to users depending on their account positions in the contract. For example, if buying a first token from the pool 106, only an LP of the pool 106 can access a low fee trading function, and among the LPs only those where the combined number of the first token owned by the given LP is less than an initial combined position.

In a particular case, if the thresholding sub engine 126 determines (1) that the request A 116 is a buy transaction and (2) that the current net token quantity is less than or equal to the initial net token quantity, the thresholding sub engine 126 can allow the trade or not apply an additional fee. Alternatively, if after the thresholding sub engine 126 determines that the request A 116 is a buy transfer, the thresholding sub engine 126 determines (3) that the current net token quantity is more than or equal to the initial net token quantity, the thresholding sub engine 126 can block the trade or apply an additional fee.

If the thresholding sub engine 126 determines (1) that the request A 116 is a sell transaction and (2) that the current net token quantity is more than or equal to the initial net token quantity, the thresholding sub engine 126 can similarly allow the trade or not apply an additional fee. Alternatively, if after the thresholding sub engine 126 determines that the request A 116 is a sell transfer, the thresholding sub engine 126 determines (3) that the current net token quantity is less than or equal to the initial net token quantity, the thresholding sub engine 126 can block the trade or apply an additional fee.

In some implementations, the timing sub engine 128 determines one or more restrictions to apply or not apply to the request A 116. For example, restrictions can include timing restrictions. In some cases, the request A 116 can include a requested transfer of a percentage (e.g., 100% or 99%) of funds from an LP pool account to a non-pool account. The request A 116 can represent an LP removing their liquidity and ceasing to be an LP.

In order to prevent short-term LPs from benefiting from low, or no trade fees, as discussed in this document, the timing sub engine 128 can determine how long an entity requesting the request A 116 has been an LP, if they are an LP. The timing sub engine 128 can determine LP time, e.g., by parsing data from the blockchain 108 indicating one or more initial transactions that originated from the given entity—identified by a unique identifier—to the given pool account—similarly uniquely identified. The timing sub engine 128 can compare an elapse time, generated from such an initial transaction—e.g., making a given use an LP—recorded in the blockchain 108 to a current time, to a threshold time—e.g., one week or other appropriate time. The timing sub engine 128 can block the trade, or apply trade fees, if the time does not satisfy the timing threshold. The timing sub engine 128 can process the trade with no, or reduced fees, if the time does satisfy the timing threshold.

Of course, alternative, or additional, rules can be applied, according to the smart contract 112, in corresponding processing by the thresholding sub engine 126 or other sub engines.

After processing the request A 116, the smart contract processing engine 120 can adjust one or more values stored in the blockchain—e.g., one or more values representing account values associated with the requesting entity. In some implementations, the smart contract processing engine 120 generates a hash value that satisfies one or more hashing requirements. For example, the smart contract processing engine 120 can generate a new block of the blockchain 108 to store transactions that indicate process results of the smart contract 114 applied to the request A 116. The entity 110 can perform one or more consensus algorithms with other nodes of the environment 100 to determine an agreed processing result for the request A 116 applied to the smart contract 114.

In some cases, the request A 116 affects the state of the contract on the blockchain 108. As part of the blockchain, it can also affect a state of the blockchain 108. The state can include Account Balances in a native crypto (e.g., ETH for Ethereum, Avax for avalanche), smart contract code, storage of parameters or balances within a particular contract, or a nonce (e.g., to help ensure sequential transactions). When a transaction is executed, the entity 110 can change the state, e.g., by transferring Ether between accounts, posting new contracts on the blockchain, updating smart contract storage, or modifying account nonces. Functions that do not affect a state can be considered read-only, or ‘getter’ functions, which can be free in terms of fees applied. A transaction that potentially changes the state can cost a fee, such as a gas fee, which can be represented as a product of the gas price multiplied by an amount of gas used, where gas represents a combination of CPU and memory impact of a transaction.

One or more additional requests can be processed in a similar way, e.g., requests B and C 140 and 150. One or more transactions can affect one or more rules that are applied in the smart contract 114 by a processing device, such as the smart contract processing engine 120. For example, after initiating a transfer of tokens using the request A 116, a current net quantity of tokens of the entity 102 can be changed. For a subsequent request, such as the request B 140 or the request C 150, different results of thresholding or processing may be produced. For example, after an initial transfer of tokens, the entity 102a might become eligible or ineligible for reduced or no fees for subsequent trades. As explained in this document, this dynamic thresholding allows the AMM of the environment 100 to improve efficiency and eliminate IL for LPs.

User transactions can affect a user's balances, e.g., either on a contract or in changes in tokens attributed to a user's externally owned account (EOA). Transactions can also change a contract's state which can affect a user's account balances, or the value of a user's account balances. This can affect privileges of users. For example, if users sell large amounts of a first token, causing a price of the first token in the AMM to decline, a passive LP can see an increase in its first token pool positions, which can affect the ability of that LP to trade at a discount on that AMM.

The requests, and corresponding data results, can be stored in the same or different blocks of the blockchain 108. Different blocks are shown in FIG. 1 for ease of illustration and readability. Blocks can include sequences of transactions that can affect a state. Memory constraints can limit a number of transactions in a given block.

Bitcoin introduced the blockchain and digital currency as a store of wealth and payment system. Unlike the standard fiat monetary system, these transactions are processed on a blockchain, a decentralized ledger secured by cryptography, and a prudent incentive structure for those maintaining this ledger. Its benefits are that it is transparent, pseudonymous, immutable, and permissionless so that individuals can achieve unprecedented financial privacy and security. While many find this technology frivolous or dangerous, enough appreciate this technology so that the total market value of blockchain coins and tokens is about $1.3 trillion.

In general, automated market makers (AMMs) can include two sets of participants: liquidity providers (LPs) and traders. LPs deposit tokens into a smart contract's trading pool, such as the pool 106, so traders can swap one token for another. In most swap AMMs (e.g., TraderJoe, Uniswap, PancakeSwap), LP's deposit tokens into a smart contract's trading pool to receive trading fees (e.g., 0.3% of notional traded). Traders swap tokens by sending one token from their externally Owned Account (EOA), and receiving a different token from the pool into their EOA. In perpetual swap AMMs, the AMM math is applied to trades as in swap AMMs, but trader's must deposit tokens onto the contract as collateral, and trades create long or short positions on the contract subject to a margin requirement. Entities of the environment 100 can include traders and LPs. LPs can be a subset of the trader classification. A token can represent a particular asset, such as Bitcoin, Ethereum, or the US dollar (the latter including ‘stablecoins’). A trade can be processed using a smart contract that is configured to add one token and remove the other from the LPs' pool, such as the pool 106.

In AMMs that do not rely on an oracle, the LP pool position is adversely affected when prices move—where price can be determined using a constant product of the amount of tokens in the pools 106a-b, among other methods of determine price in an AMM. This adverse effect can be referred to as ‘impermanent loss’ (IL) by AMM participants. One example of IL can be represented as:

ILₜⁱ=USDCₜⁱ+pₜ·ETHₜⁱ−(USDCᵢₙᵢₜⁱ+pₜ·ETHᵢₙᵢₜⁱ)

Where IL represents the difference in the value of the initial pair of token quantities {USDᵢₙᵢₜ, ETHᵢₙᵢₜ} to the value of the LP's current token quantities, {USDₜ, ETHₜ}, at the current price of ETH, pₜ.

In general, when an AMM price falls, traders can sell a first token that is decreasing in price and receive another token (e.g., ETH for USD tokens). In this case, the LP collective is accumulating the token that is decreasing in value (e.g., ETH) and losing the token that is comparatively increasing in value (e.g., USD tokens).

This contrasts with standard exchanges as liquidity providers in AMMs cannot directly move their offered prices. Rather, the AMM price can be moved by trades which then change the price based on the changed levels of tokens in the corresponding trading pools—e.g., using a constant product AMM. In this way, LPs can be adversely affected because they necessarily accumulate more of the token that is decreasing in value and lose the token that is increasing in value, e.g., in one typical trading scenario. This represents an existential threat to blockchains and the use of the technology to improve the computational operations of transactions. Without liquidity providers, users cannot effectively trade for tokens that are functional within the blockchain ecosystem. Using the techniques described in this document, the inherent loss outlined above, can be eliminated using an improved method for trading on a decentralized blockchain, e.g., using the smart contract 114.

In general, the IL for a given LP, such as the entity 102, can be quantified. For example, if pₜ represents price at a given time t and p₀ represents price at a given initial time, the following expression can represent the IL for a given LP:

$$IL = liquidity \cdot ( \sqrt{{p}_{t}} - \sqrt{{p}_{0}} ) + {p}_{t} \cdot liquidity \cdot ( \frac{1}{\sqrt{{p}_{t}}} - \frac{1}{\sqrt{{p}_{0}}} )$$

It can be shown that IL accumulates as price pₜ moves from an initial price p₀. Larger losses occur for larger changes in price.

In contrast to traditional markets, the blockchain's decentralized nature makes it orders of magnitude slower and more expensive to update than market makers within a traditional market. The cost for standard market makers adjusting their posted bids and offers can be approximately zero, including minor costs for computer messages interacting with a database (e.g., the cost of electricity).

In contrast, LP action on a blockchain can cost from $0.1 to $50—e.g., including gas prices. Blockchain speed of transactions can range from hundreds of milliseconds to tens of seconds, while on centralized exchanges, market makers can experience maximum response times of tens of milliseconds. This cost and latency of the blockchain contribute to the unique problem facing AMMs in the blockchain ecosystem. The techniques described in this document are well suited to solve this problem as they do not require continual adjustments from LPs to help eliminate impermanent loss as prices change.

In some cases, the cost of transacting on the blockchain can prevent an LP from using dynamic strategies the way traditional market makers do. AMM LPs are subject to the same IL as a percent of their pool position with no way to build an efficiency advantage within the AMM. In traditional AMMs, all AMM LPs share an unavoidable IL.

In some cases, an AMM price can be set by arbitrage. This arbitrage can be performed by traders that do not provide liquidity, and therefore do not incur impermanent loss. In general, trading on an AMM can be too slow to respond to price changes perceived elsewhere (e.g., on a traditional market) creating relatively easy avenues for arbitrage on an AMM.

The techniques described herein include processing trades for LPs that are “price-discovery” trades—e.g., trades that change a price of an AMM, for one or more tokens, more than a threshold amount. In this way, instead of outside traders initiating trades that remove value from LPs, LPs can initiate trades and thereby help to eliminate IL. Moreover, the techniques described configure the trades such that the net position of LPs are not changed. Because the trades do not change a net position of the LP, the IL of the system can be eliminated.

In addition, the threshold for providing such trades can be set to limit the number of trades generated within a blockchain system. In this way, electricity required to mine hash values for recording transactions in the blockchain can be reduced and the efficiency of eliminating IL can be increased. For example, without limits for non-LP traders, trades between non-LP and LP traders would accumulate and cause an increase in electricity and processing requirements. In contrast, a smart contract, such as the smart contract 114 can be configured to limit the number of trades to those LP traders that can then effectively set a price without incurring IL as a group.

This approach can makes token swapping, perpetual contracts, and stablecoins complementary. Techniques described can reduce the number of transactions, separated accounts, or smart contracts needed to give users access to these services. Techniques described can reduce an amount of capital needed by a factor of three because the same capital is used for all these services. To the extent some LPs try to hedge their IL, which does not eliminate their LP but does reduce its variance (e.g., changes its variance but not its mean or expected value), techniques described can remove the need for extra capital to be used for hedging LP IL.

In some implementations, the techniques described reduce energy or CPU usage. For example, the smart contract 114 can use fewer variables because a processor of the smart contract 114 does not have to update data on the endpoints of LP ranges, which is necessary in more capital efficient AMMs. There can be hundreds of restricted range endpoints (e.g., a set of ranges might exist for prices 99.0, 99.1, 99.2, among others), and, without techniques described, these would be updated on every trade. Further, a trade that crosses a range applies a different level of liquidity, doubling the trade's execution operands and operators; if a trade is large enough it can cross two ranges, tripling computing cost, among other costs. The techniques described, including the configured smart contract 114 can track an LP's net account value or its net position in the digital tokens, or a combination of these. By tracking this value, tracking the other values can be removed to reduce the size and processing requirements of processing the smart contract 114.

In one case, a constant product AMM can have a single LP (e.g., Bob), who is also the only trader. This is a simple example to demonstrate some operations of the described techniques. The case can represent the example where the entity 102 is the only entity of the environment 100 and is performing a trade.

In this example AMM, the single entity can leverage its position, e.g., trades are leveraged because they are performed with the same entity. In processing a trade for the single entity, a smart contract operating system, such as the smart contract processing engine 120, can adjust ledger values to indicate tokens moving from a first token pool to a second token pool (e.g., ETH pool to USD pool or pool 106). This can net an LP's pool positions with subsequent trades, generating a cross-margining effect.

If the single entity is levered at 20:1, the pool tokens can be valued 20 times greater than actual token amounts invested. For example, if the single entity adds 1.0 ETH to become an LP in this AMM, and the current ETH price is 1296 USD. Although ETH and USD are used in this example, any suitable tokens can be used. There is 20× leverage for LPs, so his pool ETH is 20. With USDpool of 25,920 and 20 times LP leverage, the single entity deposits 1,296 in USD—according to this particular example. Of course, other constants and values can be used in other AMMs or systems implementing the described techniques.

The trading accounts of the single entity can reflect initial ETH and USD deposits and the borrowed amounts in pool positions, e.g.,
Initial trade account ETH=ETH deposit−borrowedETHpool=1−20=−19
trade account USD=USD deposit−borrowedUSDpool=1,296−25,920=−24,624
   Eth price $1,296
   liq=720

### Single Entity

### Account

| | | |
|---|---|---|
| Pool | Eth | +20 |
| Pool | USD | +25,920 |
| Trading | Eth | −19 |
| Trading | USD | −24,624 |
| Net | ETH | +1 |
| Net | USD | +1,296 |

The single entity's net ETH position is 1.0, initial ETH deposit. This is represented by the sum of pool ETH and trade account ETH. Liquidity number and the square root of price indicate pool positions. These positions change as the AMM's price changes, which can be driven by trades, e.g., in a constant product AMM. The single entities subsequent trades are credited and debited in his trade accounts. E.g.:
ETHpool=liquidity/sqrt(price)
trade account ETH=initial ETH deposit−initial borrowedETHpool+subsequent trades
USDpool=liquidity*sqrt(price)
trade account USD=initial USD deposit−initial borrowedUSDpool+subsequent trades
Net tokens=pool tokens+trade account tokens

As a result, the single entity example shows how a single entity, acting as the sole LP and trader within a system, can adjust price without incurring IL using a trade account and a pool account, where the combination of the accounts represents a net position of the single entity.

The techniques described in this document can be applied in the case where there is more than a single entity and not all traders are LPs, or vice versa—such as that shown in FIG. 1. In some implementations, a smart contract, such as the smart contract 114, is configured to allow an LP to trade for free on the contract. For example, the smart contract can include one or more rules that are initiated for a given trade, where, if a requesting trader is an LP, no trade charges are applied to the trade—e.g., incentivizing trades by the LP. The smart contract can be configured to initiate a charge, e.g., 0.2% for trades of non-LP traders—e.g., identified as non-LPs using an identifying subengine.

In the example case of 0.2% fees, non-LP traders that are required, by the smart contract, to pay the fee require the AMM's price to deviate by at least 0.2% from a more recent evaluation of price (e.g., from a traditional market) to initiate a value increasing trade. In contrast, the LP is incented to arbitrage trade below a change of 0.2%, or other such fee value which can vary from system to system. By promoting LPs to self-arbitrage, the configured smart contract can help eliminate IL by preventing non-LP traders from effectively trading within certain price windows.

The techniques provide, additionally, for the complex case of multiple LPs. In this case, simply specifying no fee trading for LPs might not sufficiently reduce IL for all LPs. For example, in the multiple LP scenario, a single LP can perform self-arbitrage trades—e.g., trading from a pool account to trade account for the same entity—and, thereby, create IL for the other LPs for the given AMM system.

In some implementations, a smart contract, such as the smart contract 114, is configured to enforce a trade rule using a determined value of a current net position for a given token. For example, a smart contract processing device, such as the entity 110, can obtain values representing an LP's current net token position (e.g., ETH position) compared to their initial net token position—e.g., in the chain data 118 obtained from the blockchain 108. The device, such as a node in the blockchain system, can obtain current net token position and initial net token position by parsing a ledger of a blockchain, such as the blockchain 108, and identifying account values for the given trader—e.g., trading accounts and pool accounts, such as pool 103a and pool 103b of the entity 102 which can be stored on the blockchain 108. By combining values of accounts for a first token, at a first time, the device can generate an initial net position—e.g., as described in the net quantity sub engine 124. By combining values of accounts for a second token, at a second time, the device can generate a current net position. In general, the current net position can represent any time after any time representing the initial net position.

In some implementations, the smart contract is configured such that if a current net token position of a trader requesting to buy that token is less than an initial token position, the smart contract can initiate a charge free transaction for the given trader. An initial time can be determined, e.g., by the timing sub engine 128, e.g., using the chain data 118 from the blockchain 108. The chain data 118 can include data from an LP account. The data can include LiqProviderAcct[user].initETH or liqProviderAcct[user].initUSD, or similar initial value indicators. A time corresponding to these entries can be used to determine an initial time.

In some implementations, the smart contract is configured such that if a current net token position of a trader requesting to sell that token is more than an initial token position, the smart contract can initiate a charge free transaction for the given trader. In some implementations, charge free transactions are initiated only in response to the smart contract determining the identity of the trader corresponds to a known LP. For example, the smart contract can parse one or more values stored in the blockchain indicating LP accounts. If a smart contract, such as the smart contract 114 operated by the entity 110, determines the given trader is associated with one or more accounts that provide liquidity to a pool used for an AMM that the trader is now trading using, the smart contract can initiate a charge free transaction—e.g., if one or more other conditions, such as net token position conditions, are determined by the smart contract programming to be satisfied. In this way, LPs can trade freely to adjust an AMM price to help avoid IL.

In some implementations, LPs are restricted from depositing or withdrawing tokens while they remain LPs. For example, a smart contract can be configured to deny transaction requests when the transaction is requested by an LP. In this way, the net token position for each LP can represent the relative arbitrage trading over a price movement. In some cases, LPs can deposit and withdraw, but this can require adjusting an initial token amount by any exogenous changes in the LP's account.

Using techniques described in this document, LPs can trade proportionate to their liquidity and do not require rebalancing of their pools, e.g., using outside tokens. In some implementations, to prevent parasitic short-term LPs, a smart contract can be configured to penalize short-term LPs—e.g., as processed by the timing sub engine 128. For example, if an LP provides 99% liquidity, trades would provide the LP with 99% of the fees—e.g., in one potential AMM system. The smart contract can be configured to penalize a trader that provides a threshold amount of liquidity and removes a second threshold amount of liquidity within a threshold amount of time—e.g., traders that provide 99% liquidity and attempt to remove 98% within less than one week can be charged fees sufficient to eliminate value generation from the short-term liquidity. Thresholds of liquidity can be used to enforce penalties—e.g., LPs that provide more than 90% or another threshold.

In some implementations, techniques for eliminating IL include providing an LP with both pool positions implied by liquidity and a trade account reflecting trades against the aggregate pool. A trade account for an LP can starts as a negative number, e.g., representing the number of tokens borrowed that are then contributed to a liquidity pool. However, the initial net position for an LP can generally be positive.

In some cases, LPs can have accounts that include pool and trading positions. In some implementations, a device operating a smart contract net positions across accounts—e.g., using the net quantity sub engine 124. For example, a +20 ETH pool position and a −19 ETH trade account position can be obtained by a processing device to generate a net 1.0 ETH position. In some cases, a value of an LP's account is a sum of the account's trade and pool positions.

In some implementations, a smart contract, such as the smart contract 114, is configured to initiate trades for non-LP traders with a non-zero trade fee. The non-zero trade fee can be enforced using rules of the smart contract such that, when trades are requested, the smart contract can adjust one or more account values to indicate the fee charged.

In some implementations, LP accounts qualify for a discounted fee if a processing device of a smart contract identify one or more conditions. For example, the entity 110 can identify conditions, including a movement of net token positions, e.g., if an LP requests to buy a token where their current net position of that token is greater than their initial net position of that token, the device can apply one or more fees to the buy request. In this way, IL can be eliminated in the multiple LP scenario. Conditions can be applied by the smart contract processing engine 120, including the thresholding sub engine 126. Conditions can include: (1) LP's currentNetToken<=LP's initialNetToken, buy only for zero fee and (2) LP's currentNetToken>=LP's initialNetToken, sell only for zero fee. Variations can include adding a constant so that the inequality constant is slightly higher for a buy, say 1.1 times an initial netToken amount. This can give an LP more freedom to affect prices, so they are not prohibited from buying or selling until a price moves and adjusts their net positions. If an adjustment is sufficiently small, it can still prevent LPs from dominating other LPs, or LPs posting liquidity merely to trade at low fees and then withdraw their liquidity.

In some implementations, a smart contract can be configured using one or more restrictions. For example, restrictions can include one or more of: (1) LPs cannot add or withdraw tokens from their accounts while providing liquidity or (2) LPs cannot withdraw liquidity for a certain time after providing it (e.g., one week) or less than the certain time after initiating liquidity position requires a payment of fee (e.g., from pool USD)—such as a time restriction applied by the timing sub engine 128.

In some implementations, the requests 116, 140, and 150 are requests for transfers of tokens on an AMM, such as a constant product AMM, a leveraged AMM, or a combination. The techniques described in this document include a mechanism for eliminating impermanent loss, e.g., in a constant product Automated Market Maker (AMM). Techniques can include one or more implementations of a smart contract, such as the smart contract 114. The smart contract 114 can be configured to improve AMM efficiency. In some cases, the smart contracts are provided within a Leveraged AMM (LAMM).

Decentralized contracts, such as the smart contract 114, on the blockchain 108 can allow an entity, such as a user or node in the blockchain, to swap tokens, create stablecoins, and generate positions on tokens. Some benefits of decentralized blockchains include immutability, censorship-proofness, transparency, and pseudonymity. The techniques described in this document improve on existing implementations of blockchains by providing a smart contract configured to operate in an AMM, such as a LAMM, where the techniques help to eliminate the cost for AMM LPs while generating several other efficiencies, e.g., given margin trading, allowing users to withdraw tokens representing 1 USD is simple because it just generates a debit of 1 USD in the user's account, which is seamlessly accommodated. These techniques enable the effective use of LP to sustain systems for entry into decentralized blockchains—e.g., providing the necessary value to be provided to entities joining the system.

These techniques do not require the use of an oracle, or known price outside the contract sent to the blockchain. Because third parties may hack or disable an oracle or other centralized control entity, producing incorrect values for tokens available on the blockchain or compromising benefits of the blockchain, eliminating such a centralized entity, as described in this document, can improve the security of the system while also helping to eliminate impermanent loss (IL).

In some implementations, margin accounts are used in an AMM. The margin accounts can be monitored, e.g., by a processing device operating the smart contract, to perform liquidation corresponding to one or more conditions—such as a net asset value dropping below zero or above a percentage of a required margin ratio, e.g., 20%. Margin trading can include a liquidation mechanism, such as seizing an account's assets when its market value is below 20% of the notional value of their position. For the LPs, this risk is not as pressing as making sure the LPs have positive net positions in both tokens, which can enable traders to swap one token for another.

Anyone with an account can liquidate other users. In practice they can parse the contract and monitor accounts and a current ETH price, e.g., on Binance, waiting until one became insolvent. They then get, a fee for taking over a defaulted account's $400 ETH position. The liquidator can then either withdraw ETH, or sell it on the contract. A fee can include a percentage, e.g., 5%, of the ETH notional value, and so it can provide enough cushion to sell out of the new ETH position and be profitable (e.g., price change volatility is around 2 to 5% daily).

A trading fee discount can be included in the smart contract 114 such that LPs can prevent arbitrage by non-LP traders. Consider the following example. Assume a standard trading fee of 1.0% but a discounted fee of 0% for Bob. If the AMM ETH price is within 1.0% of the ‘true’ price, only Bob can profit by buying or selling ETH until the price on the AMM equals the true price. Non-LPs have no incentive to push the AMM to its true price because their cost, 1.0%, is necessarily greater than any potential profit they could make. Thus, if the LPs consistently keep the AMM price within 1% of the true price, non-LPs will transact for reasons unrelated to discrepancies between an AMM price and its true price. This is called ‘uninformed’ trading and does not mean without any information, just not information relevant to arbitrage or small, high-frequency price movements.

Net token restrictions can be included in the smart contract 114 to prevent a subset of LPs from creating IL. This can prevent quicker or more active LPs from dominating slower LPs when setting the AMM price. Consider this example: Suppose all LPs could trade at a discount at any time. In that case, one super-efficient LP with only 1% of the total pool liquidity could monopolize the price setting trading, leaving the other 99% of LPs subject to the same IL as before—as the trading LP is effectively a non-LP trader with respect to the other LPs that contribute liquidity, e.g., to the pools 106a-b. To help prevent this, the smart contract processing engine 120 can generate the smart contract 114 that provides the LP a trade fee discount conditional on a net token position—such as ETH position, or other token—being not too much above (or below) their initial net token position when they buy (or sell). One particular example of this is shown in FIG. 1 with the smart contract processing engine 120. For example, an unconstrained speedy LP with only 1% of pool liquidity would accumulate a sizeable net token position increase as the AMM ETH price rises, as their pool position would only decrease by 1% of the purchases credited to their margin balance. Restricting the LP trade discount based on the LP's current to initial net ETH ratio prevents this situation.

Timing restrictions can be included in the smart contract 114 to prevent short-term LPs from creating IL. One objective is to reduce costs of LPs who provide genuine service for traders, providing liquidity, which means letting traders swap tokens using the pool of LP tokens. A smart contract, such as the smart contract 114, can be configured to discourage traders from using LP status to make a trade at a discounted fee only to, within an elapsed time threshold, remove liquidity or become a non-LP trader. Otherwise, non-LP traders could add liquidity, make their desired trade without fee, and then remove liquidity. While the blockchain is generally slow, if one knows a precise sequence of transactions one wants to make, these can be sent to a contract on the blockchain, such as the blockchain 108, so that the transactions occur in succession and instantaneously. Such a can give a trader discounted trading fees without providing liquidity to other traders, which violates an intent of the LP trading discount.

An LAMM can provide a swapping service, similar to Uniswap, where users can execute a swap in one transaction, e.g., with the smart contract. The LAMM can also give traders margin trading, allowing them to leverage long and short positions, though this requires them to deposit tokens into the contract as collateral. With leveraged positions, the value of the long or short positions can be greater than amount of tokens in the contract. To ensure the contract has positive amounts of both tokens in the contract so traders can still swap, the LPs are incented to keep the net amounts of both tokens constant—by hedging on the contract to avoid IL—and also positive (e.g., via the right of users to liquidate LPs with net token deficiencies, for which they get a fee).

As the contract works even while accounts have negative margin balances for USD, and withdrawing USD from the contract generates a debit in their USD margin balance, a stablecoin representing a USD position has the same value as a USD credit on the contract.

Account owners cannot double-spend withdrawn USD on the contract, and if they lose access to these stablecoins, the account will merely have a perpetual excess. There is no mechanism for anyone to access unclaimed assets within the contract.

The contract's external stablecoin balance supports the contract's USD liabilities. These liabilities are claims exchangeable for the external stablecoin, and include the LP pool balances, USDC supplied by traders as collateral, the USDC in the contract's equity account that can act as a cushion for insolvencies, accumulated USD fees owed to LPs, and any of the contract's stablecoin tokens withdrawn into their EOAs.

USDC in Contract=USD_{equityAcct}+USDₚₒₒₗ+USD_{tradeAcct}+USD_{feeAP}+Stable_{OffContract}

The sum of all user USD balances, on and off contract, exactly equal the amount of the stablecoin on the contract trading this token pair, e.g., ETH-USD trading pair—where other tokens can be used. Even if one deposits one token type, e.g., ETH, to generate a stablecoin, one first must sell the token type to generate another token balance, e.g., USD balances, that one can withdraw as the endogenous stablecoin.

Consider the initial case where there is a LAMM trading USDC and ETH. The initial deposits can be in any token but, consider USDC and ETH. Traders can withdraw a stablecoin from the contract, generating a debit in their trading account's USD position.

Over time, additional LAMMs can be created with different USDC-Token pairs. Each LAMM contract can be independent, and can have its own stablecoins in addition to the externally generated USDC stablecoin. Over time, e.g., if the LAMMs functioned efficiently, people can trust the stablecoins from the different LAMMs, treating them like USDC.

The external stablecoin can be necessary at the start because the ETH price in the contract is kept at the world price via arbitrage between the USD stablecoin and ETH, as the internally generated stablecoin has its value only because of its fungibility with USDC. In the long run, if the stables generated using pairs of tokens were accepted outside corresponding LAMMs, the LAMM generated stablecoins could replace original externally generated stablecoins, such as USDC, with the stablecoins generated by external LAMMs. This would provide the crypto network with a decentralized stablecoin that, unlike other decentralized stablecoins like MakerDao's DAI, would not rely on oracle or auctions, which are hacker attack surfaces. With multiple robust LAMM using each other's stablecoins and stablecoins having value outside the LAMMs, such as trading on independent AMMs, manipulating the various LAMM stablecoins simultaneously to defraud accounts in one LAMM would expose the manipulator to arbitrage, making the would be manipulator merely a value-adding entity for the one or more pools, e.g., in the environment 100.

With a mechanism to give LPs a discounted fee, crafted so the LPs cannot abuse this privilege and crowd out other LPs from hedging, IL can be eliminated for all LPs if they choose. Removing IL requires work, which can be delegated to a specialist. This can promote a sustainable decentralized trading mechanism for tokens. The margin trading account used for removing IL can seamlessly generate two valuable features. First, it can give an LP capital efficiency without requiring restricted ranges. Currently, restricted ranges are 10 to 100 times more capital efficient, but they double the memory and CPU requirements for an AMM. This can adds to gas costs, which reflect the energy and physical storage used by the contract. Restricted ranges can also require LPs to adjust their ranges over time because when the price moves outside their range the LP's position is effectively dead: it has no risk but accrues no revenue. The method for setting price ranges is non-trivial (10% wide, 20%), and removing liquidity sends tokens to the LP's EOA, which makes it more difficult to delegate LP management as there need to be safeguards so the delegate does not abscond with the LP's capital.

Another benefit is that it generates a superior perp trading platform on a decentralized blockchain. Existing perp markets have at least two deficiencies. First, the funding rate is a ruse to give users confidence the perp AMM's price is tied to the spot price via something powerful and decentralized, like arbitrage. The perp, and its funding rate, were created around 2016 when there were no stablecoins, and traders were eager to trade with leverage that they tolerated the defective arbitrage mechanism, the perp funding rate. In practice, arbitrageurs target perp prices at a Schelling point, an obvious benchmark, and these arbs tend to be insiders who want to promote the perp exchange by maintaining consistent prices with other exchanges. Another practical implication, however, is that insiders game their protocols to charge users 10 to 20% annually. By combing swap and perp functionality in the same contract arbitrage can tie the perp price, e.g., the price on the AMM, to the true price: if the price is too high, outsiders can sell overpriced ETH for USD on the AMM, use that USDC to buy more ETH on another exchange, sell overprice ETH for USD on the AMM, etc. To the extent the AMM has a price significantly different than on other exchanges it will provide riskless profit opportunities. Second, funding rates often require an oracle to generate a funding rate, and oracles present a hacking and censorship attack surface.

Lastly, margin trading facilitates a stablecoin and, ultimately, a completely decentralized stablecoin. The contract's endogenous stablecoin has a trading platform with a price set by arbitrage, removing the need for an oracle to assess collateral adequacy. Further, liquidations can occur on contract, removing the hacks surrounding auctions of accounts that have an insufficient margin.

Initially, an existing external stablecoin is needed to create a trusted exchange where the price is set by arbitrageurs who could trade the tokens on other accounts. Ultimately, however, with sufficient popularity and trust, the stablecoins created from various LAMMs could each feed each other so that tokens could trade at fiat prices without any regulatory attack surfaces.

In some implementations, other types of interfaces are used for devices to access the blockchain 108. For example, instead of the RPC node 104, the devices 102a-c can access the blockchain 108 directly.

As modern standard Centralized Limit Order Books (CLOBs) can operate at the 10-millisecond range, and messaging across the Atlantic takes 73 ms, a decentralized network is unlikely to be able to compete with CLOBs. The solution described in this document accepts that an AMM will be derivative as the newest information will be pushed and seen on centralized exchanges more quickly. By allowing for an entity providing value to a trading pool to trade on the smart contract at a preferential, reduced fee, and implementing constraints enforced within the smart contract, the techniques described herein can allow for the entities to dominate the arbitrage of digital assets, which can eliminate the primary market making cost for AMM LPs.

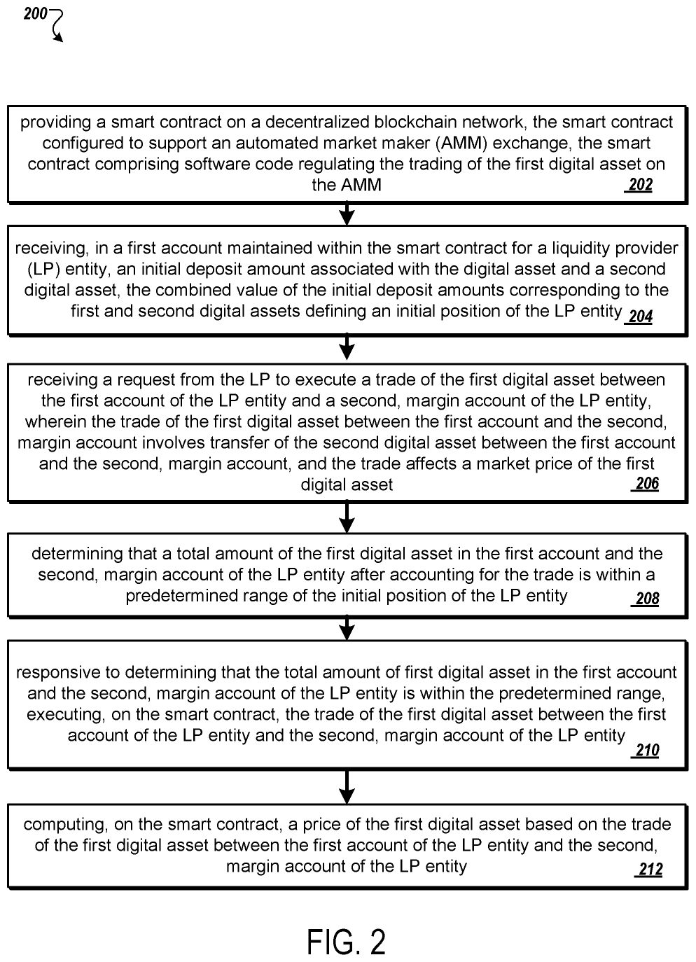

FIG. 2 shows a flowchart of an example process 200 for an AMM smart contract. For convenience, the process 200 will be described as being performed by a system of one or more computers, located in one or more locations, and programmed appropriately in accordance with this specification. For example, an entity processing device, e.g., the entity 110 and the smart contract processing engine 120 of the environment 100 shown in FIG. 1, appropriately programmed, can perform the process 200.

The process 200 includes providing a smart contract on a decentralized blockchain network, the smart contract configured to support an automated market maker (AMM) exchange, the smart contract comprising software code regulating the trading of the first digital asset on the AMM (202).

The process 200 includes receiving, in a first account maintained within the smart contract for a liquidity provider (LP) entity, an initial deposit amount associated with the digital asset and a second digital asset, the combined value of the initial deposit amounts corresponding to the first and second digital assets defining an initial position of the LP entity (204).

The process 200 includes receiving a request from the LP to execute a trade of the first digital asset between the first account of the LP entity and a second, margin account of the LP entity, wherein the trade of the first digital asset between the first account and the second, margin account involves transfer of the second digital asset between the first account and the second, margin account, and the trade affects a market price of the first digital asset (206).

The process 200 includes determining that a total amount of the first digital asset in the first account and the second, margin account of the LP entity after accounting for the trade is within a predetermined range of the initial position of the LP entity (208).

The process 200 includes responsive to determining that the total amount of first digital asset in the first account and the second, margin account of the LP entity is within the predetermined range, executing, on the smart contract, the trade of the first digital asset between the first account of the LP entity and the second, margin account of the LP entity (210).

The process 200 includes computing, on the smart contract, a price of the first digital asset based on the trade of the first digital asset between the first account of the LP entity and the second, margin account of the LP entity (212).

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

In this specification the term “engine” refers broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous

What is claimed is:

1. A method for decentralized trading of a first digital asset, the method comprising:
providing a smart contract on a decentralized blockchain network, the smart contract configured to support an automated market maker (AMM) exchange, the smart contract comprising software code regulating the trading of the first digital asset on the AMM;
receiving, in a first account maintained within the smart contract for a liquidity provider (LP) entity, an initial deposit amount associated with the digital asset and a second digital asset, the combined value of the initial deposit amounts corresponding to the first and second digital assets defining an initial position of the LP entity;
receiving a request from the LP to execute a trade of the first digital asset between the first account of the LP entity and a second, margin account of the LP entity, wherein the trade of the first digital asset between the first account and the second, margin account involves transfer of the second digital asset between the first account and the second, margin account, and the trade affects a market price of the first digital asset;
determining that a total amount of the first digital asset in the first account and the second, margin account of the LP entity after accounting for the trade is within a predetermined range of the initial position of the LP entity;
responsive to determining that the total amount of first digital asset in the first account and the second, margin account of the LP entity is within the predetermined range, executing, on the smart contract, the trade of the first digital asset between the first account of the LP entity and the second, margin account of the LP entity; and
computing, on the smart contract, a price of the first digital asset based on the trade of the first digital asset between the first account of the LP entity and the second, margin account of the LP entity.

2. The method of claim 1, further comprising computing, on the smart contract, a trade fee discount associated with the trade, the trade fee discount being computed as a function of a difference between (i) the initial position and (ii) the total amount of the first digital asset in the first account and the second, margin account of the LP entity after accounting for the trade.

3. The method of claim 1, further comprising:
receiving a withdrawal request from either the first account or the second, margin account;
determining that the withdrawal request has been received after a threshold duration from a predetermined time point; and
responsive to determining that the withdrawal request has been received after the threshold duration from the predetermined time point, initiating a fund transfer in accordance with the withdrawal request; and
storing a record of the fund transfer on the decentralized blockchain network.

4. The method of claim 3, wherein the threshold duration is one week.

5. The method of claim 1, further comprising generating a record of a stable coin based on the total amount of the digital asset in the first account and the second, margin account.

6. The method of claim 1, wherein the smart contract is provided in a leveraged automated market maker (LAMM) in the decentralized blockchain network.

7. A system comprising one or more computers and one or more storage devices on which are stored instructions that are operable, when executed by the one or more computers, to cause the one or more computers to perform operations comprising:
providing a smart contract on a decentralized blockchain network, the smart contract configured to support an automated market maker (AMM) exchange, the smart contract comprising software code regulating the trading of the first digital asset on the AMM;
receiving, in a first account maintained within the smart contract for a liquidity provider (LP) entity, an initial deposit amount associated with the digital asset and a second digital asset, the combined value of the initial deposit amounts corresponding to the first and second digital assets defining an initial position of the LP entity;
receiving a request from the LP to execute a trade of the first digital asset between the first account of the LP entity and a second, margin account of the LP entity, wherein the trade of the first digital asset between the first account and the second, margin account involves transfer of the second digital asset between the first account and the second, margin account, and the trade affects a market price of the first digital asset;
determining that a total amount of the first digital asset in the first account and the second, margin account of the LP entity after accounting for the trade is within a predetermined range of the initial position of the LP entity;
responsive to determining that the total amount of first digital asset in the first account and the second, margin account of the LP entity is within the predetermined range, executing, on the smart contract, the trade of the first digital asset between the first account of the LP entity and the second, margin account of the LP entity; and
computing, on the smart contract, a price of the first digital asset based on the trade of the first digital asset between the first account of the LP entity and the second, margin account of the LP entity.

8. The system of claim 7, wherein the operations comprise computing, on the smart contract, a trade fee discount associated with the trade, the trade fee discount being computed as a function of a difference between (i) the initial position and (ii) the total amount of the first digital asset in the first account and the second, margin account of the LP entity after accounting for the trade.

9. The system of claim 7, wherein the operations comprise:
receiving a withdrawal request from either the first account or the second, margin account;
determining that the withdrawal request has been received after a threshold duration from a predetermined time point; and
responsive to determining that the withdrawal request has been received after the threshold duration from the predetermined time point, initiating a fund transfer in accordance with the withdrawal request; and
storing a record of the fund transfer on the decentralized blockchain network.

10. The system of claim 9, wherein the threshold duration is one week.

11. The system of claim 7, wherein the operations comprise generating a record of a stable coin based on the total amount of the digital asset in the first account and the second, margin account.

12. The system of claim 7, wherein the smart contract is provided in a leveraged automated market maker (LAMM) in the decentralized blockchain network.

13. One or more computer storage media encoded with instructions that, when executed by one or more computers, cause the one or more computers to perform operations comprising:
providing a smart contract on a decentralized blockchain network, the smart contract configured to support an automated market maker (AMM) exchange, the smart contract comprising software code regulating the trading of the first digital asset on the AMM;
receiving, in a first account maintained within the smart contract for a liquidity provider (LP) entity, an initial deposit amount associated with the digital asset and a second digital asset, the combined value of the initial deposit amounts corresponding to the first and second digital assets defining an initial position of the LP entity;
receiving a request from the LP to execute a trade of the first digital asset between the first account of the LP entity and a second, margin account of the LP entity, wherein the trade of the first digital asset between the first account and the second, margin account involves transfer of the second digital asset between the first account and the second, margin account, and the trade affects a market price of the first digital asset;
determining that a total amount of the first digital asset in the first account and the second, margin account of the LP entity after accounting for the trade is within a predetermined range of the initial position of the LP entity;
responsive to determining that the total amount of first digital asset in the first account and the second, margin account of the LP entity is within the predetermined range, executing, on the smart contract, the trade of the first digital asset between the first account of the LP entity and the second, margin account of the LP entity; and
computing, on the smart contract, a price of the first digital asset based on the trade of the first digital asset between the first account of the LP entity and the second, margin account of the LP entity.

14. The storage media of claim 13, wherein the operations comprise computing, on the smart contract, a trade fee discount associated with the trade, the trade fee discount being computed as a function of a difference between (i) the initial position and (ii) the total amount of the first digital asset in the first account and the second, margin account of the LP entity after accounting for the trade.

15. The storage media of claim 13, wherein the operations comprise:
receiving a withdrawal request from either the first account or the second, margin account;
determining that the withdrawal request has been received after a threshold duration from a predetermined time point; and
responsive to determining that the withdrawal request has been received after the threshold duration from the predetermined time point, initiating a fund transfer in accordance with the withdrawal request; and
storing a record of the fund transfer on the decentralized blockchain network.

16. The storage media of claim 15, wherein the threshold duration is one week.

17. The storage media of claim 13, wherein the operations comprise generating a record of a stable coin based on the total amount of the digital asset in the first account and the second, margin account.

18. The storage media of claim 13, wherein the smart contract is provided in a leveraged automated market maker (LAMM) in the decentralized blockchain network.
